(19) United States
(12) Patent Application Publication
(10) Pub. No.: US 2022/0011258 A1
(43) Pub. Date: Jan. 13, 2022

(54) GAS SENSOR AND METHOD FOR CONTROLLING GAS SENSOR

(71) Applicant: NGK INSULATORS, LTD., Nagoya (JP)

(72) Inventors: Takayuki SEKIYA, Nagoya (JP); Yusuke WATANABE, Nagoya (JP)

(21) Appl. No.: 17/487,027

(22) Filed: Sep. 28, 2021

Related U.S. Application Data
(63) Continuation of application No. PCT/JP2020/014019, filed on Mar. 27, 2020.

(30) Foreign Application Priority Data
Mar. 29, 2019 (JP) 2019-065604

(51) Int. Cl. G01N 27/406; G01N 27/407; G01N 27/41

(52) U.S. Cl. CPC G01N 27/4067; G01N 27/41; G01N 27/4071

(57) ABSTRACT

Provided are a gas sensor and a method for controlling the gas sensor, wherein the gas sensor comprises: a heater unit which performs a temperature adjustment of heating and keeping a sensor element warm; a pump drive control unit which controls pump driving for at least a gas-to-be measured flow unit; a measurement pump cell which detects a concentration of a specific gas in the gas to be measured, on the basis of an electromotive force generated between a reference electrode and a measurement electrode; a heater control unit which controls the heater unit; and a pump stop unit which stops the pump driving by the pump drive control unit after the heater control unit stops energizing the heater unit.

### CROSS-REFERENCE TO RELATED APPLICATIONS

This application is a Continuation of International Application No. PCT/JP2020/014019 filed on Mar. 27, 2020, which is based upon and claims the benefit of priority from Japanese Patent Application No. 2019-065604 filed on Mar. 29, 2019, the contents all of which are incorporated herein by reference.

### TECHNICAL FIELD

The present invention relates to a gas sensor and a method for controlling a gas sensor.

### BACKGROUND ART

The gas sensor disclosed in JP 2018-077115 A is directed to achieving an object of suppressing deterioration of the measurement accuracy of the gas sensor caused by substances being adsorbed on an electrode, without causing a time period to occur in which usage of the gas sensor is disabled.

In order to achieve the aforementioned object, in the gas sensor according to JP 2018-077115 A, at a time of initiating the gas sensor, which is equipped with a sensor element made up from an oxygen ion conductive solid electrolyte, at least one electrode provided on the sensor element and in contact with a gas to be measured, and a control means for controlling the gas sensor, the sensor element is heated for a predetermined time period ΔT and to a temperature T2 that is higher than a predetermined drive temperature T1, by a heater provided in the sensor element, and then the temperature of the sensor element is lowered to the predetermined drive temperature T1.

### SUMMARY OF INVENTION

Incidentally, for the electrode of the sensor element as described above, there is one in which platinum, or platinum to which a trace amount of a substance has been added is used. The sensor element is one in which an electrochemical property is utilized, and the sensor element must be heated to a high temperature (600 to 900° C.) in order to make use of this property. Since oxygen (O₂) is always present within the exhaust gas, the gas sensor separates O₂ and NO within the exhaust gas. The separated NO is decomposed into O₂ and N₂ through use of a catalytic reaction of another electrode, and the NO concentration is measured from the O₂ concentration thereof. When O₂ is exposed to a catalyst electrode, Pt and Rh of the electrode are produced from PtO, PtO₂, Rh₂O₃, etc., and such substances evaporate at a lower temperature in comparison with Pt and Rh. Further, when Pt and Rh are oxidized, the catalytic reactivity thereof is deteriorated, and furthermore, the decomposing power of the gas is lowered, and as a result, a concern arises in that the sensitivity of the sensor may be decreased.

An object of the present invention is to provide a gas sensor and a method for controlling the gas sensor, in which oxidation of the catalyst electrode can be suppressed, and in which it is possible to prevent a decrease in the sensitivity of the gas sensor.

A gas sensor according to an aspect of the present invention includes a sensor element. The sensor element includes a stacked body formed by stacking a plurality of oxygen ion conductive solid electrolyte layers, the stack body containing therein a gas to be measured flow-through section configured to introduce a gas to be measured thereinto and cause the gas to be measured to flow therethrough, and a reference gas introduction space configured to introduce a reference gas serving as a reference for detecting a concentration of a specified gas within the gas to be measured, a reference electrode formed in an interior of the stacked body, and into which the reference gas is introduced through the reference gas introduction space, a measurement electrode and an inner side pump electrode disposed on an inner peripheral surface of the gas to be measured flow-through section, and a gas to be measured side electrode disposed on a portion, of the stacked body, that is exposed to the gas to be measured. The gas sensor further includes a heater unit configured to perform temperature adjustment for heating the sensor element and keeping the sensor element hot, a pump drive control unit configured to control pump-driving with respect to at least the gas to be measured flow-through section, a detection unit configured to detect a concentration of the specified gas within the gas to be measured, based on an electromotive force generated between the reference electrode and the measurement electrode, a heater control unit configured to control the heater unit, and a pump stopping unit configured to stop pump-driving by the pump drive control unit, after supply of electric current to the heater unit by the heater control unit has been stopped.

In a method for controlling a gas sensor, according to another aspect of the present invention, the gas sensor includes a sensor element. The sensor element includes a stacked body formed by stacking a plurality of oxygen ion conductive solid electrolyte layers, the stacked body containing therein a gas to be measured flow-through section configured to introduce a gas to be measured thereinto and cause the gas to be measured to flow therethrough, and a reference gas introduction space configured to introduce a reference gas serving as a reference for detecting a concentration of a specified gas within the gas to be measured, a reference electrode formed in an interior of the stacked body, and into which the reference gas is introduced through the reference gas introduction space, a measurement electrode and an inner side pump electrode disposed on an inner peripheral surface of the gas to be measured flow-through section, and a gas to be measured side electrode disposed on a portion, of the stacked body, that is exposed to the gas to be measured. The gas sensor further includes a heater unit configured to perform temperature adjustment for heating the sensor element and keeping the sensor element hot. The method for controlling the gas sensor includes a step of controlling pump-driving with respect to at least the gas to be measured flow-through section, a step of detecting a concentration of the specified gas within the gas to be measured, based on an electromotive force generated between the reference electrode and the measurement electrode, and a step of stopping pump-driving after supply of electric current to the heater unit has been stopped.

According to the present invention, oxidation of the catalyst electrode can be suppressed, and it is possible to prevent a decrease in the sensitivity of the gas sensor.

### BRIEF DESCRIPTION OF DRAWINGS

FIG. 1 is a cross-sectional view showing a gas sensor according to a present embodiment;

FIG. 2 is a block diagram showing a configuration of a first gas sensor;

FIG. 3 is a block diagram showing a configuration of a gas sensor according to a comparative example;

FIGS. 4A, 4B, and 4C are time charts showing control operations of a gas sensor according to a comparative example;

FIGS. 5A, 5B, and 5C are time charts showing an example of control operations of a first gas sensor according to the present embodiment;

FIG. 6 is a block diagram showing a configuration of a second gas sensor;

FIG. 7 is a block diagram showing a configuration of a third gas sensor;

FIG. 8 is a block diagram showing a configuration of a fourth gas sensor;

FIG. 9 is a first table (Table 1) showing a pump-off delay time period, a light-off time period, and a temperature difference from a time when a sensor is in operation, in Examples 1 to 5 and a Comparative Example;

FIG. 10 is a graph showing changes in a light-off time period with respect to a pump-off delay time period;

FIG. 11 is a graph showing changes in the light-off time period with respect to a temperature difference from a time when the sensor is in operation;

FIG. 12 is a graph showing changes in a surface temperature of the gas sensor with respect to an elapsed time (pump-off delay time period) after a heater has been stopped; and

FIG. 13 is a block diagram showing an example of a power supplying system of a sensor controller.

### DESCRIPTION OF EMBODIMENTS

A gas sensor and a method for controlling the gas sensor according to the present invention will be presented and described in detail below with reference to the accompanying drawings.

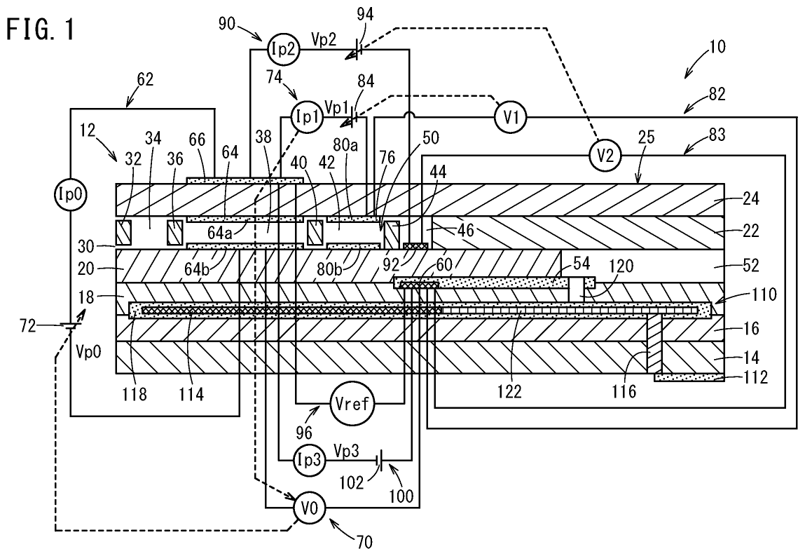

As shown in FIG. 1, a gas sensor 10 according to the present embodiment is equipped with a sensor element 12. The sensor element 12 is of an elongate rectangular body shape, the longitudinal direction of the sensor element 12 (the horizontal direction in FIG. 1) is defined as a front-rear direction, and the thickness direction of the sensor element 12 (the vertical direction in FIG. 1) is defined as an up-down direction. Further, the widthwise direction of the sensor element 12 (the direction perpendicular to the front-rear direction and the up-down direction) is defined as a left-right direction.

The sensor element 12, as shown in FIG. 1, is an element including a stacked body 25 in which six layers of a first substrate layer 14, a second substrate layer 16, a third substrate layer 18, a first solid electrolyte layer 20, a spacer layer 22, and a second solid electrolyte layer 24, made up respectively from an oxygen ion conductive solid electrolyte layer such a zirconia (ZrO₂) or the like, are stacked in this order from a lower side as viewed in the drawing. Further, the solid electrolyte that forms these six layers is dense and airtight. For example, after having performed a predetermined process and printing of circuit patterns on ceramic green sheets corresponding to the respective layers, the sensor element 12 is manufactured by stacking, and furthermore, firing and integrating the respective layers.

A gas introduction port 30, a first diffusion rate control member 32, a buffer space 34, a second diffusion rate control member 36, a first internal vacancy 38, a third diffusion rate control member 40, a second internal vacancy 42, a fourth diffusion rate control member 44, and a third internal vacancy 46 are formed adjacent to each other in this order and communicating in this manner, at one end of the sensor element 12 (the left side in FIG. 1) between a lower surface of the second solid electrolyte layer 24 and an upper surface of the first solid electrolyte layer 20.

The gas introduction port 30, the buffer space 34, the first internal vacancy 38, the second internal vacancy 42, and the third internal vacancy 46 are provided by way of hollowing out the spacer layer 22, and they are spaces in the interior of the sensor element 12, in which the upper portions thereof are defined by lower surfaces of the second solid electrolyte layer 24, the lower portions thereof are defined by upper surfaces of the first solid electrolyte layer 20, and the side portions thereof are defined by side surfaces of the spacer layer 22.

Each of the first diffusion rate control member 32, the second diffusion rate control member 36, and the third diffusion rate control member 40 is provided as two horizontally elongated slits (in which openings thereof have a longitudinal direction in a direction perpendicular to the drawing). Further, the fourth diffusion rate control member 44 is provided as a single horizontally elongated slit (in which the opening thereof has a longitudinal direction in a direction perpendicular to the drawing) formed as a gap formed under a lower surface of the second solid electrolyte layer 24. The portion from the gas introduction port 30 to the third internal vacancy 46 is also referred to as a gas to be measured flow-through section 50.

Further, at a position more distant from one end side than the gas to be measured flow-through section 50, and between the upper surface of the third substrate layer 18 and the lower surface of the spacer layer 22, a reference gas introduction space 52 is provided at a position where the side portion is defined by the side surface of the first solid electrolyte layer 20. For example, the atmospheric air is introduced into the reference gas introduction space 52 as a reference gas when measurement of the NOx concentration is performed.

An atmospheric gas introduction layer 54 is a layer made of a ceramic such as porous alumina, and which is exposed to the reference gas introduction space 52. The reference gas is introduced into the atmospheric gas introduction layer 54 through the reference gas introduction space 52. Further, the atmospheric gas introduction layer 54 is formed in a manner so as to cover a reference electrode 60. The atmospheric gas introduction layer 54 introduces the reference gas to the reference electrode 60, while imparting a predetermined diffusion resistance with respect to the reference gas inside the reference gas introduction space 52. Further, the atmospheric gas introduction layer 54 is formed in a manner so as to be exposed to the reference gas introduction space 52 on the rear end side (the right side shown in FIG. 1) of the sensor element 12, i.e., more rearward than the reference electrode 60. Stated otherwise, the reference gas introduction space 52 is not formed up to a location directly above the reference electrode 60. However, the reference electrode 60 may also be formed directly below the reference gas introduction space 52 shown in FIG. 1.

The reference electrode 60 is an electrode formed in a condition so as to be sandwiched between the upper surface of the third substrate layer 18 and the first solid electrolyte layer 20, and as noted above, the atmospheric gas introduction layer 54 which is connected to the reference gas introduction space 52 is disposed around the periphery thereof. Moreover, the reference electrode 60 is formed directly on the upper surface of the third substrate layer 18, and portions thereof other than the portion in contact with the upper surface of the third substrate layer 18 are covered by the atmospheric gas introduction layer 54. Further, as will be discussed later, using the reference electrode 60, it becomes possible to measure the oxygen concentration (oxygen partial pressure) inside the first internal vacancy 38, inside the second internal vacancy 42, and inside the third internal vacancy 46. The reference electrode 60 is formed as a porous cermet electrode (for example, a cermet electrode of Pt and ZrO₂).

In the gas to be measured flow-through section 50, the gas introduction port 30 is a site that opens with respect to the external space, and the gas to be measured is drawn into the interior of the sensor element 12 from the external space through the gas introduction port 30. The first diffusion rate control member 32 is a location that imparts a predetermined diffusion resistance with respect to the gas to be measured which is drawn in from the gas introduction port 30. The buffer space 34 is a space provided in order to guide the gas to be measured that is introduced from the first diffusion rate control member 32 to the second diffusion rate control member 36. The second diffusion rate control member 36 is a location that imparts a predetermined diffusion resistance with respect to the gas to be measured which is drawn into the first internal vacancy 38 from the buffer space 34. The gas to be measured is introduced from the exterior of the sensor element 12 to the interior of the first internal vacancy 38 as follows. That is, due to pressure fluctuations of the gas to be measured in the external space (pulsations in the exhaust pressure, in the case that the gas to be measured is an exhaust gas of an automobile), the gas to be measured is rapidly drawn into the sensor element 12 from the gas introduction port 30. The gas is not introduced directly into the first internal vacancy 38, but rather, is introduced into the first internal vacancy 38 after such fluctuations in the concentration of the gas to be measured are canceled by passing through the first diffusion rate control member 32, the buffer space 34, and the second diffusion rate control member 36. Consequently, fluctuations in the concentration of the gas to be measured that is introduced into the first internal vacancy 38 become almost negligible. The first internal vacancy 38 is provided as a space for adjusting the oxygen partial pressure within the gas to be measured that is introduced through the second diffusion rate control member 36. The concerned oxygen partial pressure is adjusted by operation of a later-described main pump cell 62.

The main pump cell 62 is an electrochemical pump cell, which is constituted by an inner side pump electrode 64 disposed on the inner surface of the first internal vacancy 38, an outer side pump electrode 66 disposed in a region corresponding to the inner side pump electrode 64 within the upper surface of the second solid electrolyte layer 24 in a manner of being exposed to the external space, and the second solid electrolyte layer 24 which is sandwiched between the two pump electrodes.

The inner side pump electrode 64 is formed to span over the upper and lower solid electrolyte layers (the first solid electrolyte layer 20 and the second solid electrolyte layer 24) that partition the first internal vacancy 38, and the spacer layer 22 that serves as the side walls. More specifically, a ceiling electrode portion 64a of the inner side pump electrode 64 is formed on a lower surface of the second solid electrolyte layer 24, which serves as a ceiling surface of the first internal vacancy 38, and further, a bottom electrode portion 64b is formed directly on an upper surface of the first solid electrolyte layer 20, which serves as a bottom surface of the first internal vacancy 38. In addition, side electrode portions (not shown) are formed on side wall surfaces (inner surfaces) of the spacer layer 22 constituting both side wall portions of the first internal vacancy 38 such that the ceiling electrode portion 64a and the bottom electrode portion 64b are connected. Thus, the inner side pump electrode 64 is disposed as a structure in which a tunnel formation is formed at the location where the side electrode portions are disposed.

The inner side pump electrode 64 and the outer side pump electrode 66 are formed as porous cermet electrodes (for example, cermet electrodes of ZrO₂ and Pt containing 1% of Au). Moreover, the inner side pump electrode 64 which is in contact with the gas to be measured is formed using a material that weakens the reduction capability with respect to the NOx component within the gas to be measured.

In the main pump cell 62, a desired pump voltage Vp0 is applied between the inner side pump electrode 64 and the outer side pump electrode 66, and a pump current Ip0 is made to flow in a positive direction or a negative direction between the inner side pump electrode 64 and the outer side pump electrode 66, whereby the oxygen inside the first internal vacancy 38 can be pumped out to the external space, or alternatively, the oxygen in the external space can be pumped into the first internal vacancy 38.

Further, in order to detect the oxygen concentration (oxygen partial pressure) within the atmosphere inside the first internal vacancy 38, an electrochemical sensor cell, and more specifically, an oxygen partial pressure detecting sensor cell 70 for controlling the main pump (also referred to as a main pump controlling sensor cell 70), is constituted by the inner side pump electrode 64, the second solid electrolyte layer 24, the spacer layer 22, the first solid electrolyte layer 20, and the reference electrode 60.

By measuring the electromotive force V0 in the main pump controlling sensor cell 70, it becomes possible to comprehend and determine the oxygen concentration (oxygen partial pressure) inside the first internal vacancy 38. Furthermore, the pump current Ip0 is controlled by feedback-controlling the pump voltage Vp0 of the variable power supply 72 in a manner so that the electromotive force V0 becomes constant. Consequently, the oxygen concentration inside the first internal vacancy 38 can be maintained at a predetermined constant value.

The third diffusion rate control member 40 imparts a predetermined diffusion resistance to the gas to be measured, the oxygen concentration (oxygen partial pressure) of which is controlled by operation of the main pump cell 62 in the first internal vacancy 38, and guides the gas to be measured into the second internal vacancy 42.

The second internal vacancy 42 is provided as a space for further carrying out adjustment of the oxygen partial pressure by an auxiliary pump cell 74, with respect to the gas to be measured which is introduced through the third diffusion rate control member 40, after the oxygen concentration (oxygen partial pressure) has been adjusted beforehand in the first internal vacancy 38. In accordance with this feature, the oxygen concentration inside the second internal vacancy 42 can be kept constant with high accuracy, and therefore, in the gas sensor 10, it becomes possible to measure the NOx concentration with high accuracy.

The above-described auxiliary pump cell 74 is an auxiliary electrochemical pump cell, which is constituted by an auxiliary pump electrode 76 provided on an inner surface of the second internal vacancy 42, the outer side pump electrode 66 (without being limited to the outer side pump electrode 66, any suitable pump electrode on the outer side of the sensor element 12 suffices), and the second solid electrolyte layer 24.

The auxiliary pump electrode 76 is arranged in the interior of the second internal vacancy 42, in a structure having a tunnel formation similar to that of the inner side pump electrode 64 provided in the interior of the above-described first internal vacancy 38. Stated otherwise, a ceiling electrode portion 80a is formed on the second solid electrolyte layer 24, which serves as a ceiling surface of the second internal vacancy 42, and further, a bottom electrode portion 80b is formed directly on an upper surface of the first solid electrolyte layer 20, which serves as a bottom surface of the second internal vacancy 42. In addition, side electrode portions (not shown) connecting the ceiling electrode portion 80a and the bottom electrode portion 80b are formed respectively on both wall surfaces of the spacer layer 22, which serves as the side walls of the second internal vacancy 42. In this manner, a tunnel-shaped structure is formed. Moreover, in the same manner as the inner side pump electrode 64, the auxiliary pump electrode 76 is also formed using a material that weakens the reduction capability with respect to the NOx component within the gas to be measured.

In the auxiliary pump cell 74, by applying a desired voltage Vp1 between the auxiliary pump electrode 76 and the outer side pump electrode 66, it becomes possible to pump out oxygen within the atmosphere inside the second internal vacancy 42 into the external space, or alternatively, to pump in oxygen from the external space into the interior of the second internal vacancy 42.

Further, in order to control the oxygen partial pressure within the atmosphere in the interior of the second internal vacancy 42, an electrochemical sensor cell, and more specifically, an oxygen partial pressure detecting sensor cell 82 for controlling the auxiliary pump (also referred to as an auxiliary pump controlling sensor cell 82), is constituted by the auxiliary pump electrode 76, the reference electrode 60, the second solid electrolyte layer 24, the spacer layer 22, and the first solid electrolyte layer 20.

Moreover, the auxiliary pump cell 74 carries out pumping by a variable power supply 84, the voltage of which is controlled based on an electromotive force V1 detected by the auxiliary pump controlling sensor cell 82. Consequently, the oxygen partial pressure within the atmosphere inside the second internal vacancy 42 is controlled so as to become a low partial pressure that does not substantially influence the measurement of NOx.

Further, together therewith, a pump current Ip1 thereof is used to control the electromotive force of the main pump controlling sensor cell 70. More specifically, the pump current Ip1 is input as a control signal to the main pump controlling sensor cell 70, and by controlling the electromotive force V0 thereof, the gradient of the oxygen partial pressure within the gas to be measured, which is introduced from the third diffusion rate control member 40 into the interior of the second internal vacancy 42, is controlled to remain constant at all times. When used as a NOx sensor, by the actions of the main pump cell 62 and the auxiliary pump cell 74, the oxygen concentration in the interior of the second internal vacancy 42 is maintained at a constant value on the order of 0.001 ppm.

The fourth diffusion rate control member 44 imparts a predetermined diffusion resistance to the gas to be measured, the oxygen concentration (oxygen partial pressure) of which is controlled by operation of the auxiliary pump cell 74 in the second internal vacancy 42, and guides the gas to be measured into the third internal vacancy 46. The fourth diffusion rate control member 44 fulfills a role of limiting the amount of NOx that flows into the third internal vacancy 46.

The third internal vacancy 46 is provided as a space for performing a process in relation to measurement of the nitrogen oxide (NOx) concentration within the gas to be measured, with respect to the gas to be measured which is introduced through the fourth diffusion rate control member 44, after the oxygen concentration (oxygen partial pressure) has been adjusted beforehand in the second internal vacancy 42. Measurement of the NOx concentration is primarily performed in the third internal vacancy 46 by operation of a measurement pump cell 90.

The measurement pump cell 90 performs measurement of the NOx concentration within the gas to be measured in the interior of the third internal vacancy 46. The measurement pump cell 90 is an electrochemical pump cell constituted by a measurement electrode 92, which is disposed directly on the upper surface of the first solid electrolyte layer 20 facing toward the third internal vacancy 46, the outer side pump electrode 66, the second solid electrolyte layer 24, the spacer layer 22, and the first solid electrolyte layer 20. The measurement electrode 92 can be, for example, a porous cermet electrode. The measurement electrode 92 also functions as a NOx reduction catalyst for reducing NOx existing within the atmosphere inside the third internal vacancy 46.

In the measurement pump cell 90, it is possible to pump out oxygen that is generated by the decomposition of nitrogen oxide within the atmosphere around the measurement electrode 92, and to detect such a generated amount as a pump current Ip2.

Further, in order to detect the oxygen partial pressure around the measurement electrode 92, an electrochemical sensor cell, and more specifically, a measurement pump controlling sensor cell 83, is constituted by the first solid electrolyte layer 20, the measurement electrode 92, and the reference electrode 60. A variable power supply 94 is controlled based on an electromotive force V2 detected by the measurement pump controlling sensor cell 83.

The gas to be measured which is guided into the interior of the second internal vacancy 42 reaches the measurement electrode 92 of the third internal vacancy 46 through the fourth diffusion rate control member 44 under a condition in which the oxygen partial pressure is controlled. Nitrogen oxide existing within the gas to be measured around the measurement electrode 92 is reduced (2NO→N₂+O₂) to thereby generate oxygen. In addition, such generated oxygen is subjected to pumping by the measurement pump cell 90, and at this time, the voltage Vp2 of the variable power supply 94 is controlled in a manner so that the electromotive force V2 detected by the measurement pump controlling sensor cell 83 becomes constant. Since the amount of oxygen generated around the measurement electrode 92 is proportional to the concentration of nitrogen oxide within the gas to be measured, the nitrogen oxide concentration within the gas to be measured can be calculated using the pump current Ip2 of the measurement pump cell 90.

Further, an electrochemical sensor cell 96 is constituted by the second solid electrolyte layer 24, the spacer layer 22, the first solid electrolyte layer 20, the third substrate layer 18, the outer side pump electrode 66, and the reference electrode 60, and based on an electromotive force Vref obtained by the sensor cell 96, it is possible to detect the oxygen partial pressure within the gas to be measured existing externally of the sensor.

Furthermore, an electrochemical reference gas adjusting pump cell 100 is constituted by the second solid electrolyte layer 24, the spacer layer 22, the first solid electrolyte layer 20, the third substrate layer 18, the outer side pump electrode 66, and the reference electrode 60. The reference gas adjusting pump cell 100 carries out pumping by a control current Ip3 being made to flow due to a voltage Vp3 applied by a variable power supply 102, which is connected between the outer side pump electrode 66 and the reference electrode 60. Consequently, the reference gas adjusting pump cell 100 draws in oxygen from the space around the outer side pump electrode 66 into the space (the atmospheric gas introduction layer 54) around the reference electrode 60. The voltage Vp3 of the variable power supply 102 is determined beforehand as a DC (direct current) voltage, in a manner so that the control current Ip3 becomes a predetermined value (a DC current of a constant value).

Further, in the reference gas adjusting pump cell 100, the area of the reference electrode 60, the control current Ip3, the voltage Vp3 of the variable power supply 102, and the like are determined beforehand, in a manner so that the average current density of the reference electrode 60 when the control current Ip3 flows therethrough becomes in excess of 0 μA/mm² and less than 400 μA/mm². In this instance, the average current density implies a current density obtained by dividing an average value of the control current Ip3 by an area S of the reference electrode 60. The area S of the reference electrode 60 is an area of a portion of the reference electrode 60 that faces toward the atmospheric gas introduction layer 54, and according to the present embodiment, is an area (a length in a front-rear direction×a width in a left-right direction) of an upper surface of the reference electrode 60. Since the vertical thickness of the reference electrode 60 is extremely smaller than the length in the front-rear direction and the width in the left-right direction of the reference electrode 60, the area of the side surfaces (the front, rear, left, and right surfaces) of the reference electrode 60 can be ignored. The average value of the control current Ip3 is a value obtained by time-averaging the control current for a sufficiently long predetermined period during which momentary changes in the control current Ip3 can be ignored. The average current density is preferably less than or equal to 200 μA/mm², more preferably, is less than or equal to 170 μA/mm², and even more preferably, is less than or equal to 160 μA/mm². The area S of the reference electrode 60 is preferably less than or equal to 5 mm². Although not particularly limited thereto, the length of the reference electrode 60 in the front-rear direction, for example, is 0.2 to 2 mm, and the width in the left-right direction, for example, is 0.2 to 2.5 mm. The average value of the control current Ip3, for example, is 1 to 100 μA. The average value of the control current Ip3 is preferably greater than or equal to 1 μA, more preferably, is greater than or equal to 4 μA, still more preferably, is greater than or equal to 5 μA, and even more preferably, is greater than or equal to 8 μA.

In the gas sensor 10 having such a configuration, by operating the main pump cell 62 and the auxiliary pump cell 74, the gas to be measured, in which the oxygen partial pressure thereof is always maintained at a constant low value (a value that does not substantially exert an influence on the measurement of NOx), is imparted to the measurement pump cell 90. Accordingly, it becomes possible for the NOx concentration within the gas to be measured to be known, on the basis of the aforementioned pump current Ip2, which flows by pumping out, from the measurement pump cell 90, the oxygen generated by the reduction of NOx substantially in proportion to the concentration of NOx within the gas to be measured.

Furthermore, the sensor element 12 is equipped with a heater unit 110 which performs temperature adjustment for heating the sensor element 12 and keeping the sensor element 12 hot, for the purpose of increasing the oxygen ion conductivity of the solid electrolyte. The heater unit 110 comprises heater connector electrodes 112, a heater 114, through holes 116, a heater insulating layer 118, a pressure release hole 120, and lead wires 122.

The heater connector electrodes 112 are electrodes that are formed so as to be in contact with the lower surface of the first substrate layer 14. By the heater connector electrodes 112 being connected to an external power source, it becomes possible for electrical power to be supplied from the exterior to the heater unit 110.

The heater 114 is an electric resistor formed in a state of being sandwiched from above and below between the second substrate layer 16 and the third substrate layer 18. The heater 114 is connected to the heater connector electrodes 112 via the lead wires 122 and the through holes 116, generates heat by being supplied with electrical power from the exterior through the heater connector electrodes 112, and carries out heating and heat-retention of the solid electrolyte that forms the sensor element 12.

Further, the heater 114 is embedded over the entire region from the buffer space 34 to the third internal vacancy 46, whereby the entire sensor element 12 is made capable of being adjusted to a temperature at which the solid electrolyte is activated.

The heater insulating layer 118 is an insulating layer made of porous alumina formed by an insulator of alumina or the like on the upper and lower surfaces of the heater 114. The heater insulating layer 118 is formed with the aim of obtaining electrical insulation between the second substrate layer 16 and the heater 114, as well as electrical insulation between the third substrate layer 18 and the heater 114.

The pressure release hole 120 is a site that is provided so as to penetrate through the third substrate layer 18 and communicate with the reference gas introduction space 52, and is formed with the aim of alleviating an increase in the internal pressure accompanying a rise in the temperature inside the heater insulating layer 118.

Moreover, the variable power supplies 72, 84, 94, and 102 and the like shown in FIG. 1 are actually connected to the electrodes via non-illustrated lead wires, or via connectors and lead wires formed in the interior of the sensor element 12.

Next, a description will be given below of an example of the method of manufacturing such a gas sensor 10. Initially, six unfired ceramic green sheets containing an oxygen ion conductive solid electrolyte such as zirconia or the like as a ceramic component thereof are prepared. A plurality of sheet holes used for positioning at a time of printing and at a time of stacking and required through holes are formed beforehand in the green sheets. Further, in the green sheet that serves as the spacer layer 22, a space that serves as the gas to be measured flow-through section 50 is formed in advance by punching or the like. In addition, corresponding to each of the first substrate layer 14, the second substrate layer 16, the third substrate layer 18, the first solid electrolyte layer 20, the spacer layer 22, and the second solid electrolyte layer 24, a pattern printing process and a drying process, which form various patterns on the ceramic green sheets, are carried out. More specifically, the patterns that are formed, for example, are patterns for the aforementioned electrodes, the lead wires 122 connected to the electrodes, the atmospheric gas introduction layer 54, the heater unit 110, and the like. Pattern printing is carried out by applying a pattern-forming paste prepared according to characteristics required for each of formation targets onto a green sheet using a well-known screen printing technique. The drying process is also carried out using a well-known drying means. When pattern printing and drying have been completed, a process is carried out of printing and drying an adhesive paste in order to stack and adhere the green sheets corresponding to the respective layers to each other. Then, the green sheets on which the adhesive paste is formed are stacked in a predetermined order while being positioned by the sheet holes, and a press bonding process is carried out thereon to press bond the green sheets by application of a predetermined temperature and pressure condition, thereby producing a single stacked body 25. The stacked body 25 obtained in this manner is one in which a plurality of individual sensor elements 12 are included. The stacked body 25 is cut and separated into a plurality of pieces having the size of the sensor element 12. Then, the stacked body 25 that has been cut and separated is fired at a predetermined firing temperature, and the sensor element 12 is obtained.

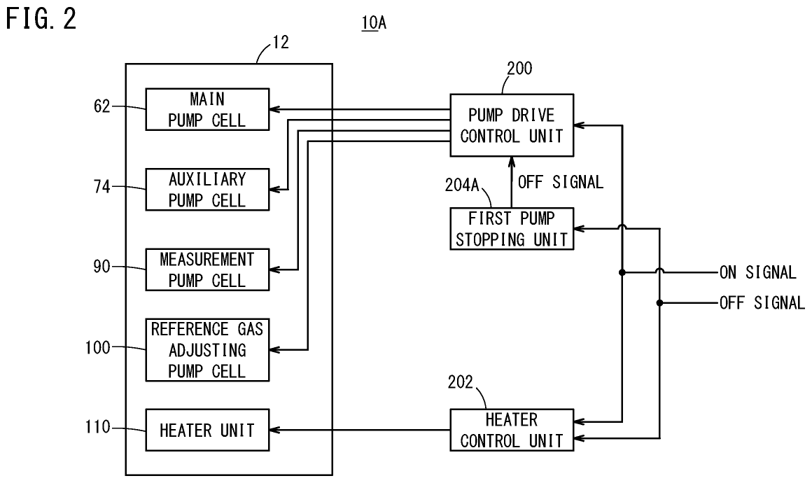

Herein, a number of exemplary embodiments in relation to the gas sensor 10 according to the present embodiment will be described with reference to FIGS. 2 to 8.

Initially, as shown in FIG. 2, the gas sensor according to a first exemplary embodiment (hereinafter referred to as a first gas sensor 10A) includes the aforementioned sensor element 12, a pump drive control unit 200, a heater control unit 202, and a first pump stopping unit 204A.

The pump drive control unit 200 controls pump-driving (pumping oxygen from the gas to be measured flow-through section 50) with respect to the gas to be measured flow-through section 50 (see FIG. 1). The heater control unit 202 controls supply and stopping of electric current to the heater unit 110. The first pump stopping unit 204A stops pump-driving by the pump drive control unit 200, after the heater control unit 202 has stopped supplying electric current to the heater unit 110.

The pump drive control unit 200, the heater control unit 202, and the first pump stopping unit 204A are constituted, for example, by one or a plurality of CPUs (central processing units), and one or more electronic circuits including a storage device and the like. The electronic circuits are software-based functional units in which predetermined functions are realized, for example, by the CPUs executing programs stored in a storage device. Of course, the electronic circuits may be constituted by an integrated circuit such as an FPGA (Field-Programmable Gate Array), in which the plurality of electronic circuits are connected according to the functions thereof. The same features apply hereinafter.

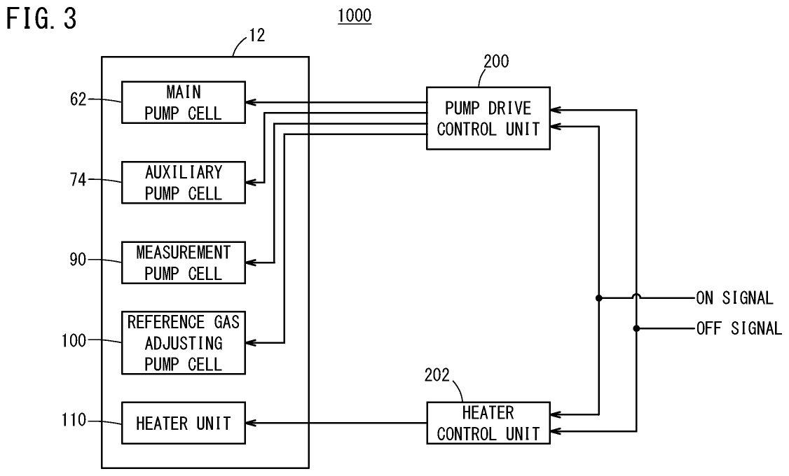

On the other hand, as shown in FIG. 3, a gas sensor 1000 according to a comparative example includes the aforementioned sensor element 12, the pump drive control unit 200, and the heater control unit 202.

The pump drive control unit 200 at least controls pump-driving (pumping oxygen from the gas to be measured flow-through section 50) with respect to the gas to be measured flow-through section 50. The heater control unit 202 controls supply and stopping of electric current to the heater unit 110.

Next, a control method for the first gas sensor 10A will be described while making a comparison thereof with a control method of the comparative example.

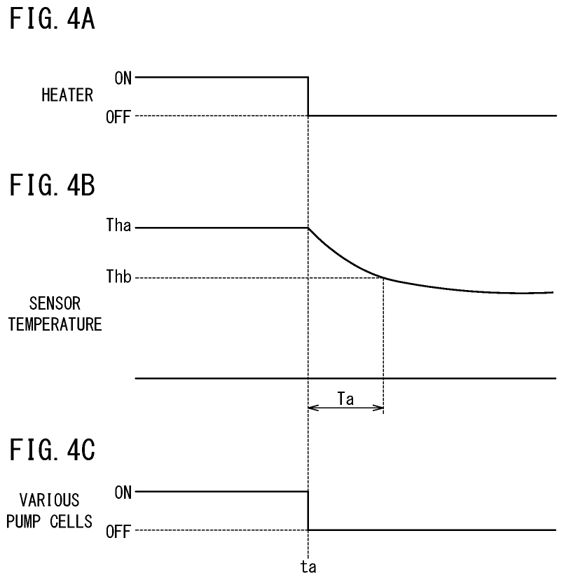

At first, in the control method of the comparative example, as shown in FIGS. 3 and 4A to 4C, by inputting an ON signal to the pump drive control unit 200 and the heater control unit 202, various types of pump cells are driven, and supply of current to the heater unit 110 is carried out. Thereafter, as shown in FIG. 4B, the temperature of the sensor element 12 (hereinafter referred to as a sensor temperature) is substantially maintained at a first temperature Tha (for example, 800° C.) which is a high temperature.

In addition, as shown in FIG. 4C, at an energization stopping time point ta, by an OFF signal being input to the pump drive control unit 200 and the heater control unit 202, driving of the various pump cells is stopped, while at the same time, supply of current to the heater unit 110 is also stopped. At this time, as shown in FIG. 4B, although the sensor temperature gradually decreases after the supply of current to the heater unit 110 is stopped, the sensor temperature is maintained over a fixed period Ta at a high temperature which is greater than or equal to a predetermined temperature Thb (for example, 500° C.) Immediately after the supply of current to the heater unit 110 has been stopped, the temperature thereof is not lowered immediately, and a high temperature state is continued for a while. When, in such a high temperature state, the exhaust gas enters into the gas to be measured flow-through section 50 which is not subjected to pump-driving, the catalyst electrodes (the reference electrode 60, the inner side pump electrode 64, the auxiliary pump electrode 76, the measurement electrode 92, etc.) are oxidized by the oxygen within the exhaust gas. More specifically, in the aforementioned fixed period Ta, oxidation of the catalyst electrodes occurs. Further, the aforementioned effect of electrode oxidation discussed above not only causes a decrease in the sensitivity of the gas sensor 1000, but also causes an increase in the time period (the light-off time period) from when operation of the gas sensor 1000 is started to when the gas sensor 1000 becomes stabilized.

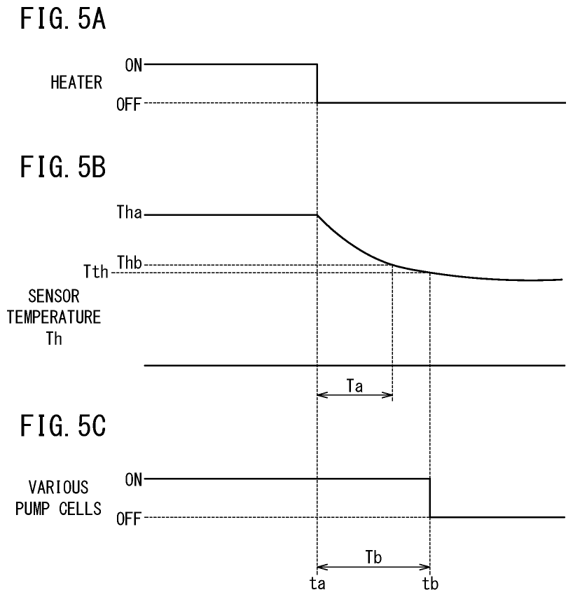

In contrast thereto, as shown in FIGS. 2 and 5A to 5C, the first pump stopping unit 204A of the first gas sensor 10A delays the OFF signal that was input, and outputs the OFF signal to the pump drive control unit 200, after the heater control unit 202 has stopped supplying current to the heater unit 110. More specifically, at a time point tb which is later than the energization stopping time point ta when the supply of current to the heater unit 110 is stopped, pump-driving by the pump drive control unit 200 is stopped.

Consequently, pump-driving by the pump drive control unit 200 is continued over a period from the energization stopping time point ta when the supply of current to the heater unit 110 is stopped to the time point tb, whereby pumping out of oxygen from the gas to be measured flow-through section 50 is carried out. As a result, oxidation of the reference electrode 60, the measurement electrode 92, etc. is suppressed, and a decrease in the sensitivity of the first gas sensor 10A is prevented.

Further, as discussed previously, since electrode oxidation is suppressed, the time period (the light-off time period) from when operating of the first gas sensor 10A is started to when the first gas sensor 10A becomes stabilized also becomes shorter. The shorter light-off time period enables the NOx concentration to be known within an early time period from the time when the engine is started, and an improvement in product quality can be achieved.

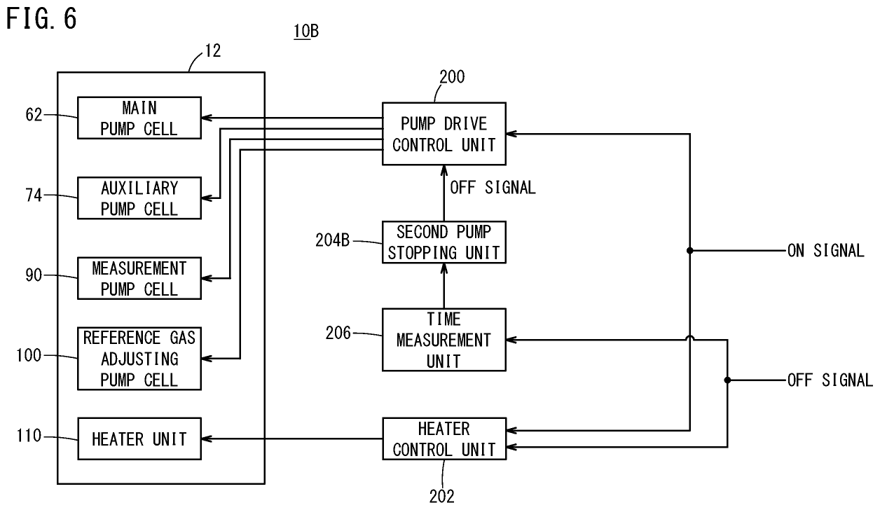

Next, as shown in FIG. 6, a gas sensor according to a second exemplary embodiment (hereinafter referred to as a second gas sensor 10B) has the same configuration as that of the first gas sensor 10A described above, but differs therefrom in that a second pump stopping unit 204B, and a time measurement unit 206 to which an OFF signal is input are included. Descriptions concerning portions thereof overlapping with those of the first gas sensor 10A will be omitted.

As shown in FIGS. 5A to 5C, the time measurement unit 206 outputs the OFF signal to the second pump stopping unit 204B, at a stage at which a predetermined time period Tb from the energization stopping time point ta when the OFF signal is input has been measured. The second pump stopping unit 204B outputs the OFF signal to the pump drive control unit 200, based on input thereto of the OFF signal from the time measurement unit 206. More specifically, at a time point tb after the predetermined time period Tb has elapsed from the energization stopping time point ta when the supply of current to the heater unit 110 is stopped, pump-driving by the pump drive control unit 200 is stopped.

In addition, by setting the predetermined time period Tb measured by the time measurement unit 206, to the time period to reach a temperature that brings about an environment in which it becomes difficult for the reference electrode 60 and the measurement electrode 92 and the like to be oxidized, the reference electrode 60 and the measurement electrode 92 and the like are exposed to an environment in which it is difficult for them to be oxidized, after pump-driving by the pump drive control unit 200 has been stopped. As a result, a decrease in the sensitivity of the second gas sensor 10B is suppressed. Moreover, as discussed previously, the time period (the light-off time period) from start of driving of the second gas sensor 10B to when the second gas sensor 10B becomes stabilized also becomes shorter.

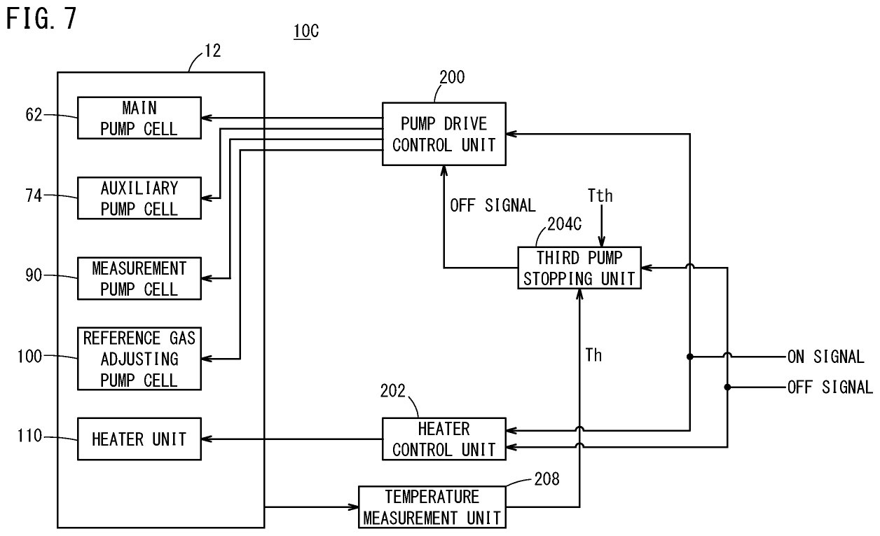

Next, as shown in FIG. 7, a gas sensor according to a third exemplary embodiment (hereinafter referred to as a third gas sensor 10C) has the same configuration as that of the first gas sensor 10A described above, but differs therefrom in that a third pump stopping unit 204C, and a temperature measurement unit 208 for measuring a temperature (sensor temperature) of the sensor element 12 are included. Descriptions concerning portions thereof overlapping with those of the first gas sensor 10A will be omitted.

The temperature measurement unit 208 measures the temperature (sensor temperature Th) of the sensor element 12, and supplies the sensor temperature Th to the third pump stopping unit 204C. The temperature measurement unit 208 measures the temperature of a specified site of the sensor element 12. The specified site, for example, may be a lower surface or a side surface of the stacked body 25, and the specified site may be the heater unit 110.

The third pump stopping unit 204C compares the sensor temperature Th that is input with the previously set threshold temperature Tth, and at a time point when the sensor temperature Th has become less than or equal to the threshold temperature Tth, an OFF signal is output to the pump drive control unit 200. For example, as shown in FIGS. 5B and 5C, at the time point tb when the sensor temperature Th has become less than or equal to the threshold temperature Tth, i.e., at a point in time after the predetermined time period Tb has elapsed from the energization stopping time point to when the supply of current to the heater unit 110 is stopped, the third pump stopping unit 204C outputs an OFF signal to the pump drive control unit 200, and pump-driving is stopped.

By setting the predetermined time period Tb to the time period to reach a temperature that brings about an environment in which it becomes difficult for the reference electrode 60 and the measurement electrode 92 and the like to be oxidized, the reference electrode 60 and the measurement electrode 92 and the like are exposed to an environment in which it is difficult for them to be oxidized, after pump-driving by the pump drive control unit 200 has been stopped. As a result, a decrease in the sensitivity of the third gas sensor 10C is suppressed. Moreover, as discussed previously, the time period (the light-off time period) from start of driving of the third gas sensor 10C to when the third gas sensor 10C becomes stabilized also becomes shorter.

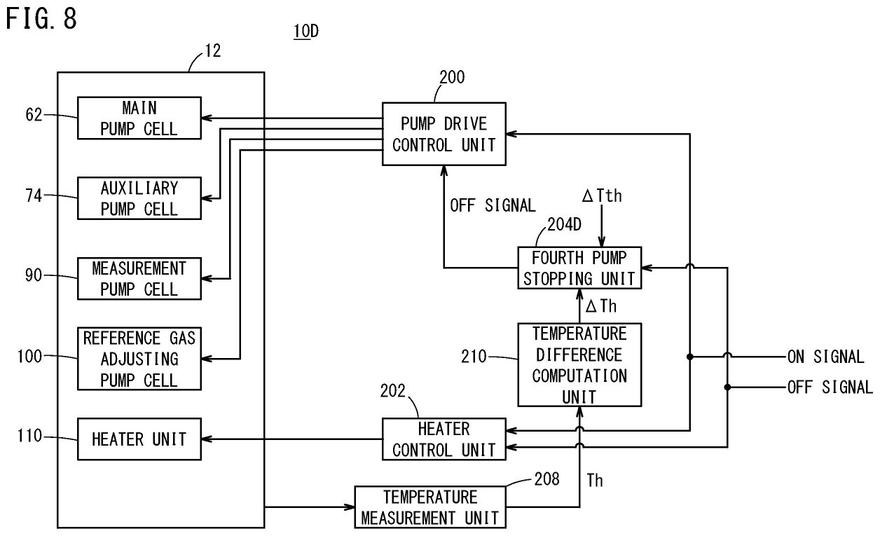

Next, as shown in FIG. 8, a gas sensor according to a fourth exemplary embodiment (hereinafter referred to as a fourth gas sensor 10D) has the same configuration as that of the third gas sensor 10C described above, but differs therefrom in that a fourth pump stopping unit 204D, and a temperature difference computation unit 210 are included. Descriptions concerning portions thereof overlapping with those of the third gas sensor 10C will be omitted.

The temperature difference computation unit 210 calculates a difference (temperature difference ΔTh) between the aforementioned first temperature Tha and the present sensor temperature Th from the temperature measurement unit 208, and outputs the temperature difference ΔTh to the fourth pump stopping unit 204D.

The fourth pump stopping unit 204D compares the temperature difference ΔTh that is input with a previously set target temperature difference ΔTth, and at a point in time when the temperature difference ΔTh has become greater than or equal to the target temperature difference ΔTth, an OFF signal is output to the pump drive control unit 200. In particular, at the time point tb when the temperature difference ΔTh has become greater than or equal to the target temperature difference ΔTth, i.e., at a point in time after the predetermined time period Tb has elapsed from the energization stopping time point to when the supply of current to the heater unit 110 is stopped, the OFF signal to the pump drive control unit 200 is output, and pump-driving is stopped.

In the same manner as noted previously, by setting the predetermined time period Tb to the time period to reach a temperature that brings about an environment in which it becomes difficult for the reference electrode 60 and the measurement electrode 92 and the like to be oxidized, the reference electrode 60 and the measurement electrode 92 and the like are exposed to an environment in which it is difficult for them to be oxidized, after pump-driving by the pump drive control unit 200 has been stopped. As a result, a decrease in the sensitivity of the fourth gas sensor 10D is suppressed. Moreover, as discussed previously, the time period (the light-off time period) from start of driving of the fourth gas sensor 10D to when the fourth gas sensor 10D becomes stabilized also becomes shorter.

### Examples

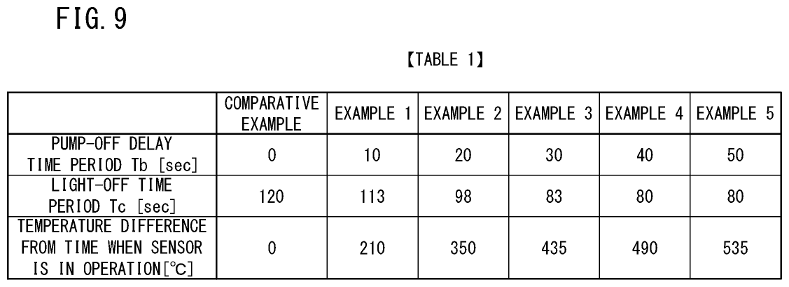

As shown in FIGS. 5A to 5C, gas sensors according to Examples 1 to 5 and a Comparative Example were driven for ten minutes in the atmosphere, and thereafter, driving of the gas sensors was stopped. At this time, a time period from the stopping time point ta of the heater when driving of the gas sensor is stopped to a time point tb when driving of the various pump cells is stopped, i.e., a pump-off delay time period Tb, is made to differ from those in Examples 1 to 5 and the Comparative Example. In that case, a light-off time period Tc and a temperature difference from a time when the sensor is in operation were confirmed concerning Examples 1 to 5 and Comparative Example. The results thereof are shown in Table 1 of FIG. 9.

Moreover, within Table 1 of FIG. 9, the “pump-off delay time period Tb” is a delay time period from the stopping time point ta of the heater to the time point tb when driving of the various pump cells is stopped. As has been discussed previously, the “light-off time period Tc” is the time period from when driving of the gas sensor is started until the gas sensor becomes stabilized. The “temperature difference from the time when the sensor is in operation” is the difference between a surface temperature of the gas sensor at a time when the sensor is in operation and a surface temperature of the gas sensor after the heater has been stopped.

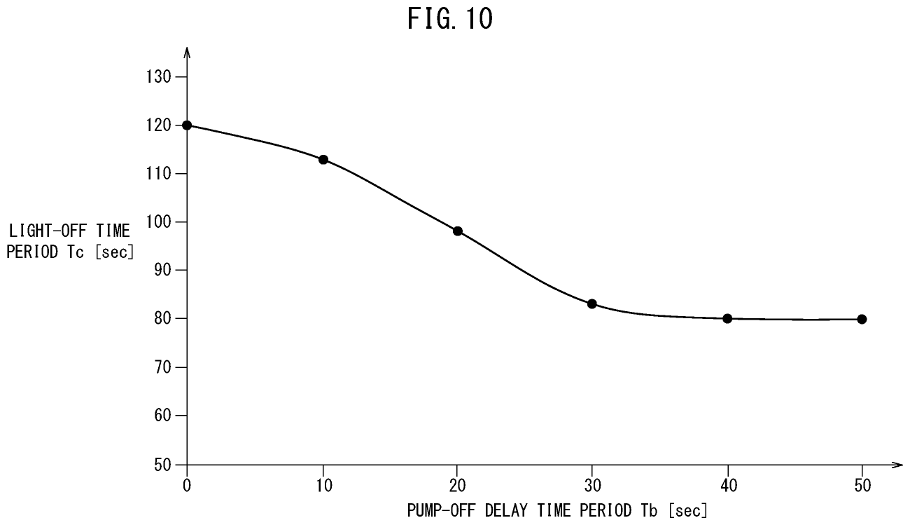

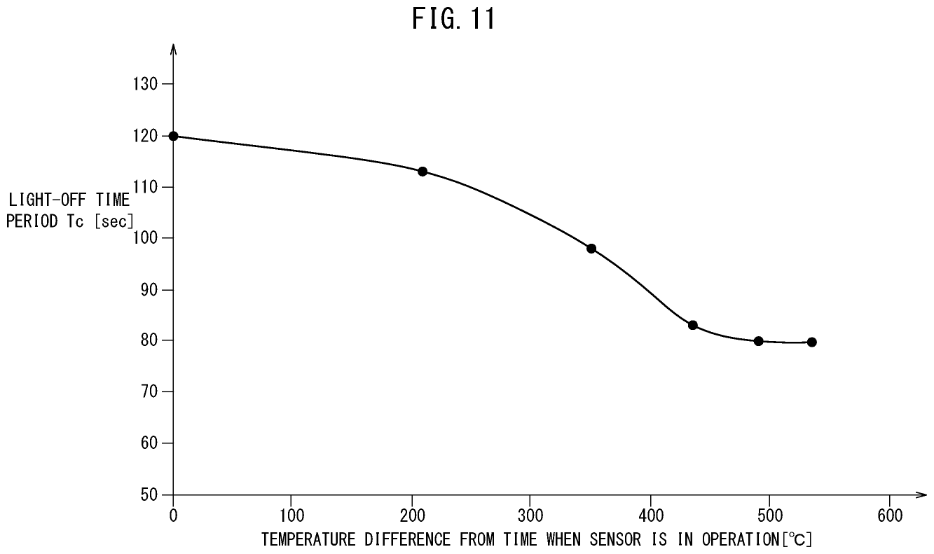

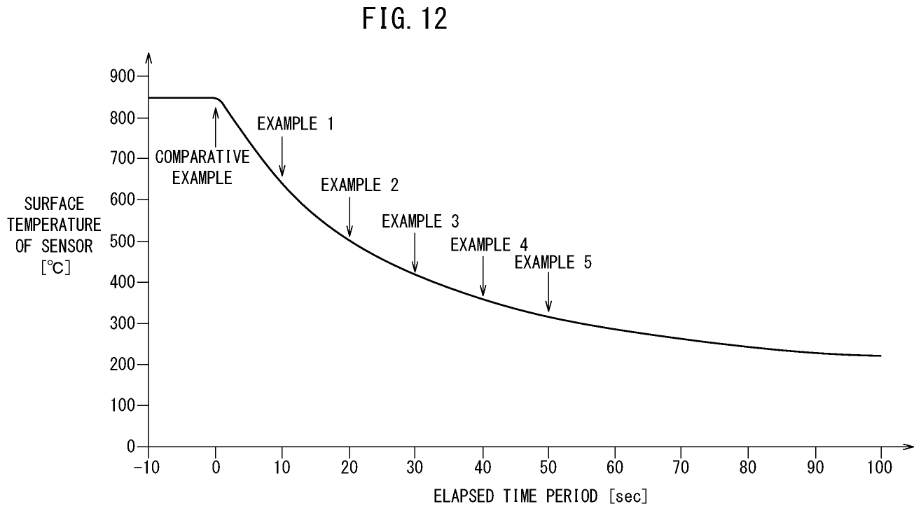

Further, on the basis of the results shown in the aforementioned Table 1, FIG. 10 shows changes in the light-off time period Tc with respect to the pump-off delay time period Tb, and FIG. 11 shows changes in the light-off time period Tc with respect to the temperature difference from the time when the sensor is in operation. Further, FIG. 12 shows changes in the surface temperature of the gas sensor with respect to an elapsed time period (the pump-off delay time period Tb) after the heater has been stopped.

### [Considerations]

From the results shown in Table 1 of FIG. 9 and FIG. 10, it can be understood that, with respect to the Comparative Example, the light-off time period Tc is capable of being shortened in all of Examples 1 to 5. More specifically, the pump-off delay time period Tb is preferably greater than or equal to 10 seconds, more preferably, is greater than or equal to 20 seconds, and even more preferably, is greater than or equal to 30 seconds.

From the results shown in Table 1 of FIG. 9 and FIG. 11, it can be understood that, with respect to the Comparative Example, the light-off time period Tc can be shortened in all of Examples 1 to 5. More specifically, the temperature difference from the time when the sensor is in operation is preferably greater than or equal to 200° C., more preferably, is greater than or equal to 350° C., and even more preferably, is greater than or equal to 435° C.

From the results shown in Table 1 of FIG. 9 and FIG. 12, it can be understood that the surface temperature of the gas sensor decreases as the pump-off delay time Tb (the elapsed time period) becomes longer. As can be understood from the results shown in FIG. 11, from the fact that the temperature difference from the time when the sensor is in operation is preferably greater than or equal to 200° C., more preferably, is greater than or equal to 350° C., and even more preferably, is greater than or equal to 435° C., the elapsed time period is preferably greater than or equal to 10 seconds, more preferably, is greater than or equal to 20 seconds, and even more preferably, is greater than or equal to 30 seconds.

The above-described embodiments can be summarized in the manner described below.

[1] The present embodiment includes the sensor element 12. The sensor element includes the stacked body 25 formed by stacking a plurality of oxygen ion conductive solid electrolyte layers, the stacked body containing therein the gas to be measured flow-through section 50 which introduces the gas to be measured thereinto and causes the gas to be measured to flow therethrough, and the reference gas introduction space 52 that introduces the reference gas serving as a reference for detecting the concentration of the specified gas within the gas to be measured, the reference electrode 60 formed in the interior of the stacked body 25, and into which the reference gas is introduced through the reference gas introduction space 52, the measurement electrode 92 and the inner side pump electrode 64 disposed on the inner peripheral surface of the gas to be measured flow-through section 50, and the gas to be measured side electrode disposed on a portion, of the stacked body 25, that is exposed to the gas to be measured. The gas sensor further includes the heater unit 110 that perform temperature adjustment for heating the sensor element 12 and keeping the sensor element hot, the pump drive control unit 200 which controls pump-driving (pumping out of oxygen from the gas to be measured flow-through section 50) with respect to at least the gas to be measured flow-through section 50, the measurement pump cell 90 that detects the concentration of the specified gas within the gas to be measured, on the basis of the electromotive force generated between the reference electrode 60 and the measurement electrode 92, the heater control unit 202 that controls the heater unit 110, and the first pump stopping unit 204A which stops pump-driving by the pump drive control unit 200, after the supply of electric current to the heater unit 110 by the heater control unit 202 has been stopped.

In the fixed period Ta from having stopped the supply of current to the heater unit 110 by the heater control unit 202, an environment is brought about in which catalyst electrodes such as the reference electrode 60 and the measurement electrode 92 and the like are easily oxidized. Immediately after the supply of current to the heater unit 110 has been stopped, the temperature thereof is not lowered immediately, and a high temperature state is continued for a while. In a high temperature state, when the exhaust gas enters into the gas to be measured flow-through section 50 which is not subjected to pump-driving, the catalyst electrode is oxidized by the oxygen in the exhaust gas.

The effect of electrode oxidation not only causes a decrease in the sensitivity of the gas sensor, but also causes a delay in the time period (the light-off time period) from when driving of the gas sensor is started to when the gas sensor becomes stabilized.

In contrast thereto, according to the present embodiment, by continuing pump-driving by the pump drive control unit 200 for at least the fixed period Ta, in the fixed period Ta, pumping out of oxygen is carried out from the gas to be measured flow-through section 50, oxidation of the reference electrode 60 and the measurement electrode 92 and the like is suppressed, and a decrease in the sensitivity of the gas sensor is prevented. In addition, as discussed previously, since electrode oxidation is suppressed, the time period (the light-off time period) from start of driving of the gas sensor to when the gas sensor becomes stabilized also becomes shorter. The shorter light-off time period enables the NOx concentration to be known within an early time period from the time when the engine is started, and an improvement in product quality can be achieved.

[2] In the present embodiment, there is further included the time measurement unit 206 that measures time based on stopping the supply of electric current to the heater unit 110, and the second pump stopping unit 204B stops pump-driving at a stage at which the time measurement unit 206 has measured at least the fixed period Ta.

When the supply of current to the heater unit 110 by the heater control unit 202 is stopped, the temperature of the gas to be measured flow-through section 50 decreases. In the fixed period Ta during which the temperature of the gas to be measured flow-through section 50 is high, an environment is brought about in which the reference electrode 60 and the measurement electrode 92 and the like are easily oxidized. By continuing pump-driving by the pump drive control unit 200 for at least the fixed period Ta, oxidation of the reference electrode 60 and the measurement electrode 92 and the like during the fixed period Ta is suppressed.

In addition, by setting the predetermined time period Tb measured by the time measurement unit 206, to the predetermined time period Tb to reach a temperature that brings about an environment in which it becomes difficult for the reference electrode 60 and the measurement electrode 92 and the like to be oxidized, the reference electrode 60 and the measurement electrode 92 and the like are exposed to an environment in which it is difficult for them to be oxidized, after pump-driving by the pump drive control unit 200 has been stopped. As a result, a decrease in the sensitivity of the gas sensor is suppressed. Moreover, as discussed previously, the time period (the light-off time period) from start of driving of the gas sensor to when the gas sensor becomes stabilized also becomes shorter.

[3] In the present embodiment, there is included the temperature measurement unit 208 that measures the temperature of the stacked body 25, wherein the third pump stopping unit 204C stops pump-driving at a stage at which the temperature of the stacked body 25 has become the previously set low temperature.

When the supply of current to the heater unit 110 by the heater control unit 202 is stopped, the temperature of the specified site of the stacked body 25 decreases. In the fixed period Ta during which the temperature of the specified site is high, an environment is brought about in which the reference electrode 60 and the measurement electrode 92 and the like are easily oxidized. By continuing pump-driving by the pump drive control unit 200 in the fixed period Ta, oxidation of the reference electrode 60 and the measurement electrode 92 and the like during the fixed period Ta is suppressed.

In addition, by setting the previously set low temperature for the temperature of the specified site, to a temperature that brings about an environment in which it becomes difficult for the reference electrode 60 and the measurement electrode 92 and the like to be oxidized, the reference electrode 60 and the measurement electrode 92 and the like are exposed to an environment in which it is difficult for them to be oxidized, after pump-driving by the pump drive control unit 200 has been stopped. As a result, a decrease in the sensitivity of the gas sensor is suppressed. Moreover, as discussed previously, the time period (the light-off time period) from start of driving of the gas sensor to when the gas sensor becomes stabilized also becomes shorter.

[4] In the present embodiment, there is further included the temperature measurement unit 208 that measures the temperature of the specified site of the stacked body 25, wherein a difference between the temperature of the specified site at a time when current is supplied to the heater unit 110 by the heater control unit 202, and the temperature of the specified site at a time when pump-driving is stopped by the fourth pump stopping unit 204D is greater than or equal to a predetermined temperature (200° C.)

In the period during which the temperature difference is less than 200° C. from having stopped the supply of current to the heater unit 110 by the heater control unit 202, an environment is brought about in which the reference electrode 60 and the measurement electrode 92 and the like are easily oxidized. By continuing pump-driving by the pump drive control unit 200 in the above-described period, oxidation of the reference electrode 60 and the measurement electrode 92 and the like during the fixed period Ta is suppressed. On the other hand, in the case that the temperature difference has become greater than or equal to 200° C., since an environment is brought about in which oxidation of the reference electrode 60 and the measurement electrode 92 and the like is unlikely to occur, pump-driving by the fourth pump stopping unit 204D is stopped.

[5] In the present embodiment, the specified site of the stacked body 25 is the heater unit 110. Measuring the temperature of the heater unit 110 leads to a site having a highest temperature within the stacked body 25 being measured. Accordingly, by using the temperature of the heater unit 110 as a reference, pump-driving by the pump drive control unit 200 can be reliably continued for a period in which the gas to be measured flow-through section 50 becomes placed in a high temperature state. Consequently, oxidation of the reference electrode 60 and the measurement electrode 92 and the like can be suppressed, and it is possible to prevent a decrease in the sensitivity of the gas sensor. Of course, such a feature also enables the light-off time period to be made shorter.

[6] In the present embodiment, the temperature measurement unit 208 measures the temperature of the specified site based on the resistance value of the heater 114 constituting the heater unit 110. If the heater 114 is constituted, for example, by platinum or the like, accompanying a rise in the temperature of the specified site, the electrical resistance of the heater 114 becomes higher. Thus, based on the resistance value of the heater 114, the temperature of the specified site can be measured.

[7] In the present embodiment, the delay time period (pump-off delay time period) from a time point when the heater 114 is stopped to a time point when driving of various pump cells is stopped is preferably greater than or equal to 10 seconds, more preferably, is greater than or equal to 20 seconds, and even more preferably, is greater than or equal to 30 seconds.

[8] In the present embodiment, a temperature difference between a time when driving of the gas sensor is stopped and a time when the gas sensor is in operation is preferably greater than or equal to 200° C., more preferably, is greater than or equal to 350° C., and even more preferably, is greater than or equal to 500° C.

[9] In the method for controlling the gas sensor according to the present embodiment, the gas sensor includes the sensor element (12). The sensor element includes the stacked body 25 formed by stacking the plurality of oxygen ion conductive solid electrolyte layers, the stacked body containing therein the gas to be measured flow-through section 50 which introduces the gas to be measured thereinto and causes the gas to be measured to flow therethrough, and the reference gas introduction space 52 that introduces the reference gas serving as a reference for detecting a concentration of the specified gas within the gas to be measured, the reference electrode 60 formed in the interior of the stacked body 25, and into which the reference gas is introduced through the reference gas introduction space 52, the measurement electrode 92 and the inner side pump electrode 64 disposed on the inner peripheral surface of the gas to be measured flow-through section 50, and a gas to be measured side electrode (the outer side pump electrode 66 and the like) disposed on a portion, of the stacked body 25, that is exposed to the gas to be measured. The gas sensor further includes the heater unit 110 that performs temperature adjustment for heating the sensor element 12 and keeping the sensor element 12 hot. The method for controlling the gas sensor includes the step (control of pump-driving) of controlling pump-driving (pumping out of oxygen from the gas to be measured flow-through section 50) with respect to at least the gas to be measured flow-through section 50, the step (detection means) of detecting the concentration of the specified gas within the gas to be measured, on the basis of the electromotive force generated between the reference electrode 60 and the measurement electrode 92, and the step of stopping pump-driving after supply of electric current to the heater unit 110 has been stopped.

In the fixed period Ta from having stopped the supply of current to the heater unit 110, an environment is brought about in which the reference electrode 60 and the measurement electrode 92 and the like are easily oxidized. Immediately after the supply of current to the heater unit 110 has been stopped, the temperature thereof is not lowered immediately, and a high temperature state is continued for a while. In a high temperature state, when the exhaust gas enters into the gas to be measured flow-through section 50 which is not subjected to pump-driving, the catalyst electrode is oxidized by the oxygen in the exhaust gas.

The effect of electrode oxidation not only causes a decrease in the sensitivity of the gas sensor, but also causes an increase in the time period (the light-off time period) from when driving of the gas sensor is started to when the gas sensor becomes stabilized.

In contrast thereto, according to the present embodiment, by continuing pump-driving for at least the fixed period Ta from having stopped the supply of current to the heater unit 110, in at least the fixed period Ta, pumping out of oxygen is carried out from the gas to be measured flow-through section 50, oxidation of the reference electrode 60 and the measurement electrode 92 and the like is suppressed, and a decrease in the sensitivity of the gas sensor is prevented. In addition, as discussed previously, since electrode oxidation is suppressed, the time period (the light-off time period) from start of driving of the gas sensor to when the gas sensor becomes stabilized also becomes shorter. The shorter light-off time period enables the NOx concentration to be known within an early time period from the time when the engine is started, and an improvement in product quality can be achieved.

[10] In the present embodiment, there is further included the step of measuring time based on stopping the supply of electric current to the heater unit 110, wherein pump-driving is stopped at a stage at which at least the fixed period Ta from having stopped the supply of electric current to the heater unit 110 has been measured.

When the supply of current to the heater unit 110 is stopped, the temperature of the gas to be measured flow-through section 50 decreases. In the fixed period Ta during which the temperature of the gas to be measured flow-through section 50 is high, an environment is brought about in which the reference electrode 60 and the measurement electrode 92 and the like are easily oxidized. By continuing pump-driving in the fixed period Ta, oxidation of the reference electrode 60 and the measurement electrode 92 and the like during the fixed period Ta is suppressed.

In addition, by setting the fixed period Ta to the time period to reach a temperature that brings about an environment in which it becomes difficult for the reference electrode 60 and the measurement electrode 92 and the like to be oxidized, the reference electrode 60 and the measurement electrode 92 and the like are exposed to an environment in which it is difficult for them to be oxidized, after pump-driving has been stopped. Thus, a decrease in the sensitivity of the gas sensor is suppressed. Moreover, as discussed previously, the time period (the light-off time period) from start of driving of the gas sensor to when the gas sensor becomes stabilized also becomes shorter.

[11] In the present embodiment, there is further included the step of measuring the temperature of the stacked body 25, wherein pump-driving is stopped at a stage at which the temperature of the stacked body 25 has become a previously set low temperature.

When the supply of current to the heater unit 110 is stopped, the temperature of the specified site of the stacked body 25 decreases. In the fixed period Ta during which the temperature of the specified site is high, an environment is brought about in which the reference electrode 60 and the measurement electrode 92 and the like are easily oxidized. By continuing pump-driving in the fixed period Ta, oxidation of the reference electrode 60 and the measurement electrode and the like during the fixed period Ta is suppressed.

In addition, by setting the above previously set low temperature for the specified site, to a temperature that brings about an environment in which it becomes difficult for the reference electrode 60 and the measurement electrode 92 and the like to be oxidized, the reference electrode 60 and the measurement electrode 92 and the like are exposed to an environment in which it is difficult for them to be oxidized, after pump-driving has been stopped. Thus, a decrease in the sensitivity of the gas sensor is suppressed. Moreover, as discussed previously, the time period (the light-off time period) from start of driving of the gas sensor to when the gas sensor becomes stabilized also becomes shorter.

[12] In the present embodiment, there is further included the step of measuring the temperature of the specified site of the stacked body 25, wherein the difference between the temperature of the specified site at a time when current is supplied to the heater unit 110 and the temperature of the specified site at a time when pump-driving is stopped is greater than or equal to 200° C.

In the fixed period Ta during which the temperature difference is less than 200° C. from having stopped the supply of current to the heater unit 110, an environment is brought about in which the reference electrode 60 and the measurement electrode 92 and the like are easily oxidized. By continuing pump-driving in the fixed period Ta, oxidation of the reference electrode 60 and the measurement electrode 92 and the like during the fixed period Ta is suppressed. On the other hand, in the case that the temperature difference has become greater than or equal to 200° C., since an environment is brought about in which oxidation of the reference electrode 60 and the measurement electrode 92 and the like is unlikely to occur, pump-driving is stopped.

[13] In the present embodiment, the specified site of the stacked body 25 is the heater unit 110. Measuring the temperature of the heater unit 110 leads to a site having a highest temperature within the stacked body 25 being measured. Accordingly, by using the temperature of the heater unit 110 as a reference, pump-driving can be reliably continued for a period in which the gas to be measured flow-through section 50 becomes placed in a high temperature state. Consequently, oxidation of the reference electrode 60 and the measurement electrode 92 and the like can be suppressed, and it is possible to prevent a decrease in the sensitivity of the gas sensor. Of course, such a feature also enables the light-off time period to be made shorter.

[14] In the present embodiment, in the step of measuring the temperature of the specified site of the stacked body 25, the temperature of the specified site is measured based on the resistance value of the heater 114 constituting the heater unit 110. If the heater 114 is constituted, for example, by platinum or the like, accompanying a rise in the temperature of the specified site, the electrical resistance of the heater 114 becomes higher. Thus, based on the resistance value of the heater 114, the temperature of the specified site can be measured.

The gas sensor and the method for controlling the gas sensor according to the present invention are not limited to the embodiments described above, and it is a matter of course that various configurations could be adopted therein without deviating from the essence and gist of the present invention.

In the above-described embodiments, although the reference gas is defined as being the atmospheric air, the reference gas is not necessarily limited to this feature, as long as it is a gas that is capable of serving as a reference for detecting the concentration of a specified gas within the gas to be measured. For example, a gas which has been adjusted beforehand to a predetermined oxygen concentration (which is greater than the oxygen concentration of the gas to be measured) may be introduced as the reference gas.

In the above-described embodiments, although the sensor element 12 detects the NOx concentration in the gas to be measured, the present invention is not necessarily limited to this feature, insofar as the sensor element 12 is capable of detecting the concentration of a specified gas within the gas to be measured. For example, the oxygen concentration within the gas to be measured may be detected.

In practicing the present invention, various configurations for improving reliability of components for an automobile may be added to such an extent that the concept of the present invention is not impaired.

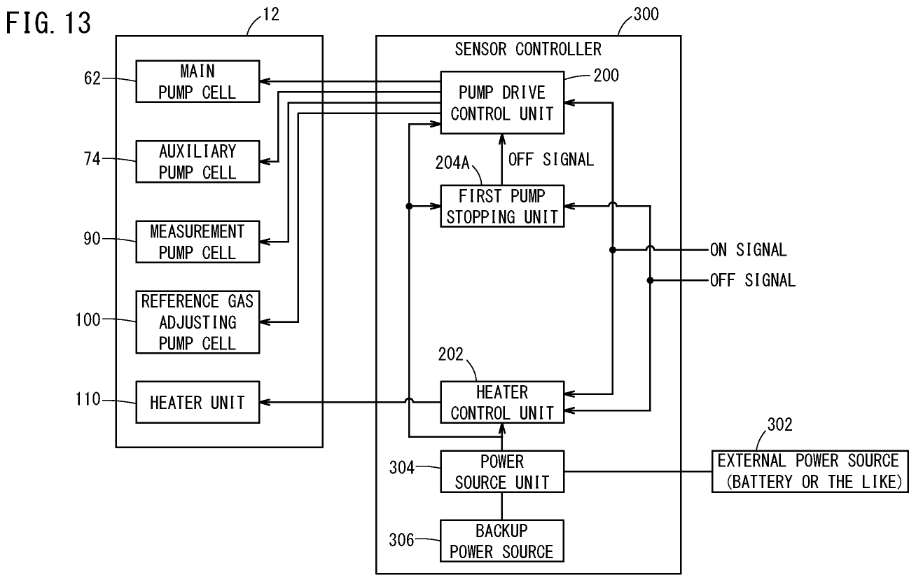

As shown in FIG. 13, in a sensor controller 300 equipped with the aforementioned pump drive control unit 200 and the like, electrical power from an external power source 302 (an automobile battery of the like) is supplied to the heater control unit 202 and the like via a power source unit 304. Therefore, when the supply of current to the sensor controller 300 is forcibly cut by a key-off operation (i.e., the engine being stopped by the driver) with respect to the automobile, cases are known to occur in which the heater 114 of the sensor element 12 and the pump are turned OFF at the same time.

Thus, in order to continue driving of the heater 114 and the pump, etc., even after such a key-off operation has been performed, the sensor controller 300 may be equipped with a backup power source 306, a storage battery, or the like for driving the pump. In accordance with this feature, even in the case that the supply of current is forcibly cut, the sensor element 12 continues to perform pumping by the power supply from the backup power source 306, the storage battery, or the like.

1. A gas sensor, comprising:
a sensor element, wherein the sensor element includes:
a stacked body formed by stacking a plurality of oxygen ion conductive solid electrolyte layers, the stacked body containing therein a gas to be measured flow-through section configured to introduce a gas to be measured thereinto and cause the gas to be measured to flow therethrough, and a reference gas introduction space configured to introduce a reference gas serving as a reference for detecting a concentration of a specified gas within the gas to be measured;
a reference electrode formed in an interior of the stacked body, and into which the reference gas is introduced through the reference gas introduction space;
a measurement electrode and an inner side pump electrode disposed on an inner peripheral surface of the gas to be measured flow-through section; and
a gas to be measured side electrode disposed on a portion, of the stacked body, that is exposed to the gas to be measured;
the gas sensor further comprising:
a heater unit configured to perform temperature adjustment for heating the sensor element and keeping the sensor element hot;
a pump drive control unit configured to control pump-driving with respect to at least the gas to be measured flow-through section;
a detection unit configured to detect a concentration of the specified gas within the gas to be measured, based on an electromotive force generated between the reference electrode and the measurement electrode;
a heater control unit configured to control the heater unit; and
a pump stopping unit configured to stop pump-driving by the pump drive control unit, after supply of electric current to the heater unit by the heater control unit has been stopped.

2. The gas sensor according to claim 1, further comprising:
a time measurement unit configured to measure time based on stopping the supply of electric current to the heater unit;
wherein the pump stopping unit stops pump-driving at a stage at which the time measurement unit has measured a predetermined time period.

3. The gas sensor according to claim 1, further comprising:
a temperature measurement unit configured to measure a temperature of the stacked body;
wherein the pump stopping unit stops pump-driving at a stage at which the temperature of the stacked body has become a previously set low temperature.

4. The gas sensor according to claim 1, further comprising:
a temperature measurement unit configured to measure a temperature of a specified site of the stacked body;
wherein a difference between a temperature of the specified site at a time when electric current is supplied to the heater unit by the heater control unit and a temperature of the specified site at a time when pump-driving is stopped by the pump stopping unit is greater than or equal to 200° C.

5. The gas sensor according to claim 4, wherein the specified site of the stacked body is the heater unit.

6. The gas sensor according to claim 5, wherein the temperature measurement unit measures the temperature of the specified site based on a resistance value of a heater constituting the heater unit.

7. The gas sensor according to claim 1, wherein a delay time period from a time point when the heater unit is stopped to a time point when driving of various pump cells is stopped is greater than or equal to 10 seconds.

8. The gas sensor according to claim 1, wherein a temperature difference between a time when driving is stopped and a time of driving is greater than or equal to 200° C.

9. A method for controlling a gas sensor, the gas sensor comprising:
a sensor element, wherein the sensor element includes:
a stacked body formed by stacking a plurality of oxygen ion conductive solid electrolyte layers, the stacked body containing therein a gas to be measured flow-through section configured to introduce a gas to be measured thereinto and cause the gas to be measured to flow therethrough, and a reference gas introduction space configured to introduce a reference gas serving as a reference for detecting a concentration of a specified gas within the gas to be measured;
a reference electrode formed in an interior of the stacked body, and into which the reference gas is introduced through the reference gas introduction space;
a measurement electrode and an inner side pump electrode disposed on an inner peripheral surface of the gas to be measured flow-through section; and
a gas to be measured side electrode disposed on a portion, of the stacked body, that is exposed to the gas to be measured;
the gas sensor further comprising a heater unit configured to perform temperature adjustment for heating the sensor element and keeping the sensor element hot;
the method for controlling the gas sensor comprising:
a step of controlling pump-driving with respect to at least the gas to be measured flow-through section;
a step of detecting a concentration of the specified gas within the gas to be measured, based on an electromotive force generated between the reference electrode and the measurement electrode; and
a step of stopping pump-driving after supply of electric current to the heater unit has been stopped.

10. The method for controlling the gas sensor according to claim 9, further comprising:
a step of measuring time based on stopping the supply of electric current to the heater unit;
wherein pump-driving is stopped at a stage at which a predetermined time period from having stopped the supply of electric current to the heater unit has been measured.

11. The method for controlling the gas sensor according to claim 9, further comprising:
a step of measuring a temperature of the stacked body;
wherein pump-driving is stopped at a stage at which the temperature of the stacked body has become a previously set low temperature.

12. The method for controlling the gas sensor according to claim 9, further comprising:
a step of measuring a temperature of a specified site of the stacked body;
wherein a difference between a temperature of the specified site at a time when electric current is supplied to the heater unit and a temperature of the specified site at a time when pump-driving is stopped is greater than or equal to 200° C.

13. The method for controlling the gas sensor according to claim 12, wherein the specified site of the stacked body is the heater unit.

14. The method for controlling the gas sensor according to claim 13, wherein, in the step of measuring the temperature of the specified site of the stacked body, the temperature of the specified site is measured based on a resistance value of a heater constituting the heater unit.
